(19) United States
(12) Patent Application Publication
(10) Pub. No.: US 2026/0287828 A1
(43) Pub. Date: Sep. 24, 2026

(54) OPTICAL CONNECTOR AND METHOD FOR ASSEMBLING OPTICAL CONNECTOR

(71) Applicant: Fujikura Ltd., Tokyo (JP)

(72) Inventor: Ryoichi Mitobe, Sakura-shi (JP)

(73) Assignee: Fujikura Ltd., Tokyo (JP)

(21) Appl. No.: 19/475,940

(22) PCT Filed: May 23, 2024
(86) PCT No.: PCT/JP2024/019112

§ 371 Date: Oct. 16, 2025

(30) Foreign Application Priority Data
Jun. 28, 2023 (JP) 2023-106473

(51) Int. Cl. G02B 6/38

(52) U.S. Cl. CPC G02B 6/3858; G02B 6/3882

(57) ABSTRACT

An optical connector includes: an optical fiber; a ferrule that has a fiber hole through which the optical fiber is inserted and a connecting end face to which the fiber hole opens; a housing that holds the ferrule; a coupling configured to be mounted onto and surround the housing; and a biasing member that biases the coupling in a direction of the connecting end face. The biasing member is configured to rotate about an axis extending in a direction that differs from a longitudinal direction of the fiber hole in a state in which the coupling is unmounted.

### TECHNICAL FIELD

The present invention relates to an optical connector and a method for assembling the optical connector.

Priority is claimed on Japanese Patent Application No. 2023-106473, filed Jun. 28, 2023, the content of which is incorporated herein by reference.

### BACKGROUND

Patent Document 1 discloses an optical connector including a ferrule, a housing, a coupling and the like. The coupling is forward biased (towards a connecting end face side of the ferrule) by a biasing member. As the biasing member, a coil spring is generally used. The coupling has a function of maintaining a state in which the optical connector is connected to an adapter. In a case where the optical connector and the adapter are disconnected, the coupling is pulled backward (to a side opposite to the connecting end face). Accordingly, it is possible to disengage the adapter and the optical connector from one other.

### PATENT LITERATURE

Patent Document 1: Japanese Unexamined Patent Application, First Publication No. 2014-13309

In the optical connector in the related art, a coil spring that biases the coupling is disposed between the housing and the coupling. In a state before the optical connector is connected to the adapter, the coupling may be removed for the purpose of suppressing bulging of the optical connector. In an optical connector of the related art, in a case where the coupling is removed, the biasing member is likely to fall off the housing. As a result, a problem of it being is difficult to perform the work of assembling the optical connector.

### SUMMARY

One or more embodiments of the invention provide an optical connector and a method for assembling the optical connector, in which it is possible to easily perform assembling.

An optical connector according to Aspect 1 of the present invention includes an optical fiber; a ferrule that has a fiber hole through which the optical fiber is inserted and a connecting end face to which the fiber hole opens, a housing that holds the ferrule, a coupling that surrounds the housing, and a biasing member that biases the coupling in a direction of the connecting end face. The biasing member is rotatable about an axis extending in a direction that differs from a longitudinal direction of the fiber hole in a state where the coupling is not mounted.

Aspect 2 of the present invention may be the optical connector according to Aspect 1, in which the biasing member may be a leaf spring.

Aspect 3 of the present invention may be the optical connector according to Aspect 1 or 2, in which the housing may have a recess that allows the biasing member to be stored therein, and a support that rotatably supports the biasing member may be disposed inside the recess.

Aspect 4 of the present invention may be the optical connector according to any one of Aspects 1 to 3, in which the biasing member may include a proximal end that is supported by the support, an abutter that is in contact with the housing, and a biaser that is positioned between the proximal end and the abutter, and is in contact with the coupling.

Aspect 5 of the present invention may be the optical connector according to any one of Aspects 1 to 4, in which the recess may have a rear storage that is positioned behind the support, and the length of the rear storage may be longer than the length from the proximal end to the abutter in the longitudinal direction.

Aspect 6 of the present invention is a method for assembling an optical connector, in which the optical connector according to any one of Aspects 1 to 5 is assembled, the method including taking out the optical connector in a state in which the coupling is not mounted from an inside of a pulling end, and rotating the biasing member about the axis and inserting the housing into the coupling.

According to the above-described aspects of the present invention, it is possible to provide an optical connector and a method for assembling an optical connector, in which it is possible to easily perform assembling.

### BRIEF DESCRIPTION OF THE DRAWINGS

FIG. 1 A perspective view of an optical connector according to one or more embodiments.

FIG. 2 A cross-sectional view taken along line II-II in FIG. 1.

FIG. 3 A perspective view of the connector before a coupling is mounted.

FIG. 4 A perspective view showing a state in which a biasing member is rotated in the connector of FIG. 3.

FIG. 5 A perspective view showing a state in which the coupling is mounted onto the connector, which is a view continued from FIG. 4.

FIG. 6 An enlarged view of a vicinity of the biasing member of FIG. 2.

FIG. 7 A diagram showing a state in which a plurality of connectors are housed inside a pulling end.

FIG. 8 A perspective view of an optical connector according to a modification example.

### DETAILED DESCRIPTION

Hereinafter, an optical connector and a method for assembling the optical connector according to one or more embodiments is explained with reference to the drawings.

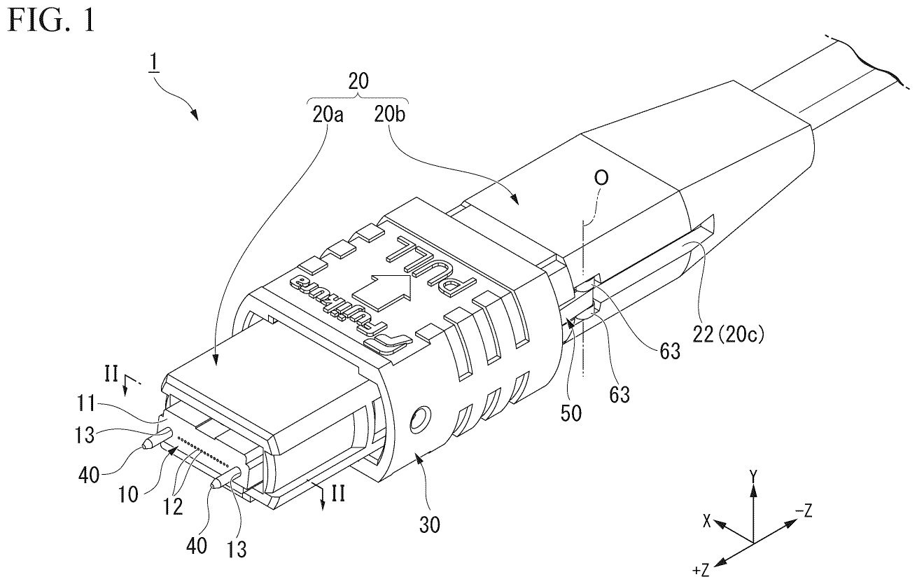

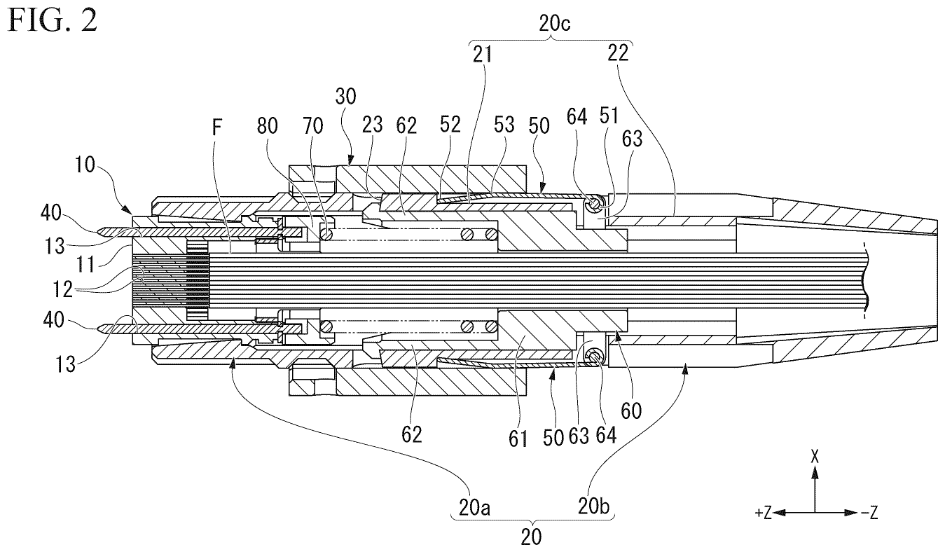

As shown in FIG. 1 and FIG. 2, the optical connector 1 includes a plurality of optical fibers F, a ferrule 10, a housing 20, and a coupling 30. The optical connector 1 shown in FIG. 1 or the like is a male type connector and includes two positioning pins 40. However, the optical connector 1 may be a female connector type. That is, the optical connector 1 may not include the positioning pins 40. The number of optical fibers F may be changed, and may be one.

The ferrule 10 has a connecting end face 11, a plurality of fiber holes 12, and two positioning holes 13. The number of fiber holes 12 can be changed, and may be one. An optical fiber F is inserted through each of the fiber holes 12. However, the optical fibers F may not be inserted into some of the fiber holes 12. That is, the number of optical fibers F may be smaller than the number of fiber holes 12. The fiber hole 12 and the positioning hole 13 are open to the connecting end face 11. The end face of the optical fiber F is exposed to the connecting end face 11.

### Definition of Direction

A direction in which the fiber hole 12 extends is referred to as a longitudinal direction Z. In the longitudinal direction Z, the connecting end face 11 side (+Z side) is referred to as a “front side” or a “distal end side”. The opposite side (−Z side) is referred to as a rear side or a proximal end side. A direction in which the two positioning holes 13 are aligned is referred to as a parallel direction X. The plurality of fiber holes 12 are aligned in the parallel direction X. A direction orthogonal to both the longitudinal direction Z and the parallel direction X is referred to as an orthogonal direction Y.

As shown in FIG. 2, the optical connector 1 includes two biasing members 50, a spring push 60, a ferrule spring 70, and a pin clamp 80. The biasing member 50 biases the coupling 30 to the front. The ferrule spring 70 biases the ferrule 10 to the front. The ferrule spring 70 is a coil spring. The plurality of optical fibers F are inserted through the inside of the ferrule spring 70.

The pin clamp 80 is disposed behind the ferrule 10. The pin clamp 80 holds the positioning pin 40. The pin clamp 80 also has a function of transmitting the biasing force of the ferrule spring 70 to the ferrule 10. The ferrule spring 70 is compressed between the pin clamp 80 and the spring push 60. As a result, an elastic force (biasing force) of the ferrule spring 70 is generated.

As shown in FIG. 1 and FIG. 2, the housing 20 includes a front member 20a and a rear member 20b. The rear member 20b may function as a so-called “boot”. The boot is a part that is provided at a rear end of the optical connector 1, and is used to relieve bending stress generated in the optical fiber. The boot may be formed of a soft material such as rubber. The front member 20a and the rear member 20b may be formed of materials that differ from one another. However, the housing 20 may be formed of a single member.

The ferrule 10, the spring push 60, the ferrule spring 70, the pin clamp 80 or the like are housed in the housing 20. The spring push 60 includes a spring seat 61 and two locking portions 62. The spring seat 61 is in contact with a rear end of the ferrule spring 70. The two locking portions 62 extend to the front from the spring seat 61. Each of the two locking portions 62 is locked to each of the two locking holes 23 of the housing 20.

The two biasing members 50 are disposed on both ends of the housing 20 in the parallel direction X. In other words, the two biasing members 50 sandwich the housing 20 therebetween in the parallel direction X. The biasing member 50 of one or more embodiments is a leaf spring. Each biasing member 50 has a proximal end 51, an abutter 52, and a biaser 53. The biasing member 50 is bent at the biaser 53. In other words, a straight line connecting the proximal end 51 and the biaser 53 and a straight line connecting the abutter 52 and the biaser 53 are not parallel to one another. The angle formed by these two straight lines is an obtuse angle.

One biasing member 50 is supported by two supports 63 (see FIG. 1) of the spring push 60 and one rotation shaft 64 (see FIG. 2). As shown in FIG. 2, the proximal end 51 has a C-shape as viewed in the orthogonal direction Y, and has the rotation shaft 64 inserted therein. The rotation shaft 64 extends in the orthogonal direction Y. Both ends of the rotation shaft 64 in the orthogonal direction Y are supported by the two supports 63. With this configuration, the biasing member 50 is rotatable about an O axis (see FIG. 1) which extends in the orthogonal direction Y. The rotation shaft 64 may be integrated with the supports 63. Alternatively, the rotation shaft 64 may be separate from the supports 63.

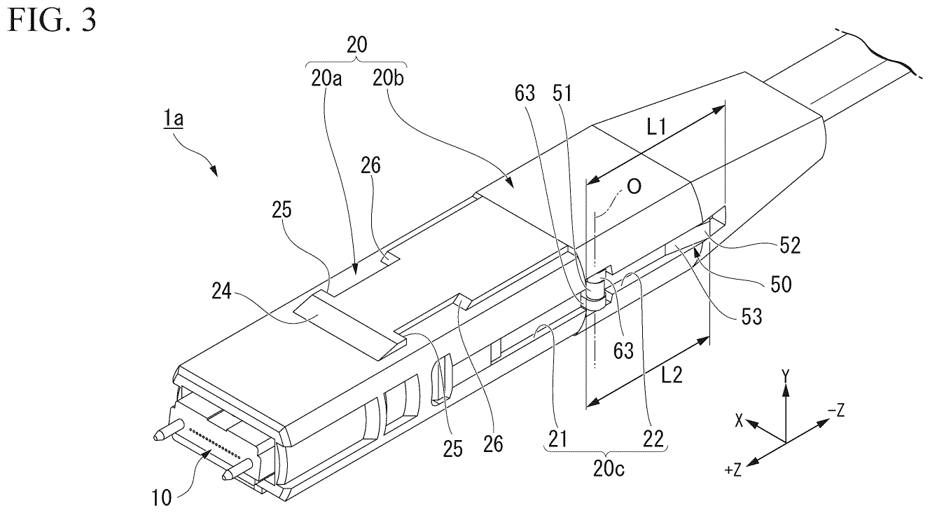

Hereinafter, as shown in FIG. 2 or the like, a state in which the biaser 53 is positioned in front of the proximal end 51 is referred to as an “assembled state”. As shown in FIG. 3 or the like, a state in which the biaser 53 is positioned behind the proximal end 51 is referred to as a “pre-assembly state”.

In one or more embodiments, two supports 63 and one rotation shaft 64 are used to rotatably support one biasing member 50. In other words, the optical connector 1 includes a total of four supports 63 and two rotation shafts 64. However, it is possible to change the specific structure as long as it is possible to rotatably support the biasing member 50.

The housing 20 has two recesses 20c in which it is possible to store the two biasing members 50. The recess 20c is formed to straddle the front member 20a and the rear member 20b. Each of the two recesses 20c has a front storage 21 formed in the front member 20a and a rear storage 22 formed in the rear member 20b. The support 63 is disposed inside the recess 20c. The front storage 21 is positioned in front of the support 63, and the rear storage 22 is positioned behind the support 63. In the parallel direction X, the depth of the rear storage 22 is greater than the depth of the front storage 21. The depth of the rear storage 22 may be set such that it is possible to store the entire biasing member 50. However, a part of the biasing member 50 may protrude from the rear storage 22 in a state in which the biasing member 50 is stored in the rear storage 22.

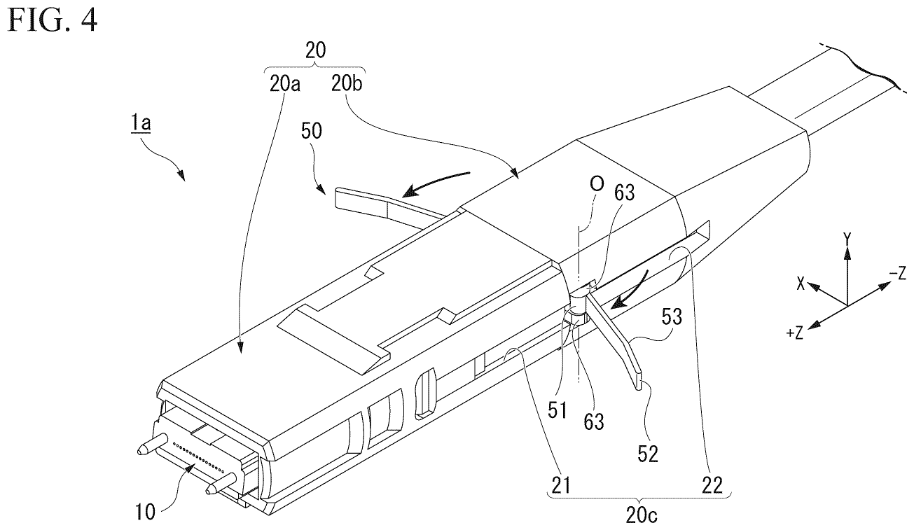

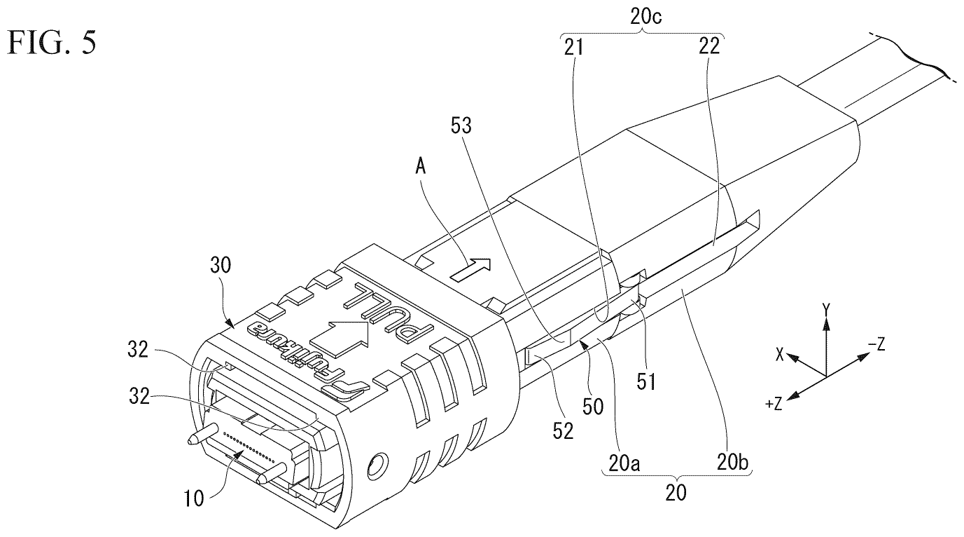

FIG. 3 to FIG. 5 show a state in a case where the optical connector 1 is assembled. FIG. 3 shows a state before the coupling 30 is attached to the housing 20. In this state (pre-assembly state), the biasing member 50 is stored in the rear storage 22. In a case where the optical connector 1 is assembled, as shown in FIG. 4, each of the two biasing members 50 is rotated to the front (+Z side). Accordingly, as shown in FIG. 5, each of the two biasing members 50 is stored in the front storage 21. In the aforementioned state (assembled state), the coupling 30 is moved to the rear (−Z side) with respect to the housing 20 as shown by the arrow A in FIG. 5. As a result, the state shown in FIG. 1 and FIG. 2 is obtained, and the assembling of the optical connector 1 is completed.

As shown in FIG. 3, one inclined surface 24, two front restriction surfaces 25, and two rear restriction surfaces 26 are formed on the housing 20. The front restriction surface 25 and the rear restriction surface 26 face one another in the longitudinal direction Z. As shown in FIG. 5, two restrictors 32 are formed in the coupling 30. In a case where the coupling 30 is moved as shown by the arrow A in FIG. 5, each restrictor 32 is moved while being in contact with the inclined surface 24 (see FIG. 3).

In a case where the restrictor 32 passes over the front restriction surface 25 to the rear, the restrictor 32 is sandwiched between the front restriction surface 25 and the rear restriction surface 26. The coupling 30 is movable to the rear with respect to the housing 20 until the restrictor 32 comes into contact with the rear restriction surface 26. The coupling 30 is movable to the front with respect to the housing 20 until the restrictor 32 comes into contact with the front restriction surface 25. In this way, the movable range of the coupling 30 with respect to the housing 20 is defined by the restrictor 32, the front restriction surface 25, and the rear restriction surface 26.

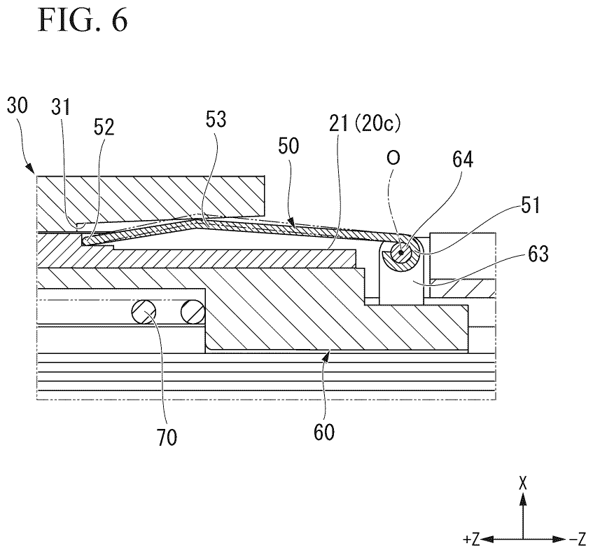

As shown in FIG. 2 and FIG. 6, in a state in which the biasing member 50 is stored in the front storage 21, the abutter 52 comes into contact with the inner surface of the front storage 21. A two-dot chain line in FIG. 6 shows a shape of the biasing member 50 in a state before the coupling 30 is mounted onto the housing 20. In other words, the two-dot chain line indicates a shape before the biasing member 50 is elastically deformed. Before the coupling 30 is mounted, the biaser 53 of the biasing member 50 protrudes outward from the recess 20c (the front storage 21) in the parallel direction X.

As shown in FIG. 6, an abutting surface 31 that comes into contact with the biaser 53 is formed on an inner wall of the coupling 30. The abutting surface 31 is inclined inward in the parallel direction X as the front side (+Z side) is approached. In a case where the coupling 30 is mounted onto the housing 20, the biaser 53 is pushed inwards in the parallel direction X by the abutting surface 31. As a result, the biasing member 50 is elastically deformed. Since the abutting surface 31 is inclined, a part of the elastic force of the biasing member 50 acts as a component force that biases the coupling 30 to the front (+Z side). In this way, the biasing member 50 biases the coupling 30 to the front.

Next, the operation of the optical connector 1 configured as described above is explained. In the following explanation, the optical connector 1 in a state where the coupling 30 is not mounted onto the housing 20 is referred to as a “connector 1a”.

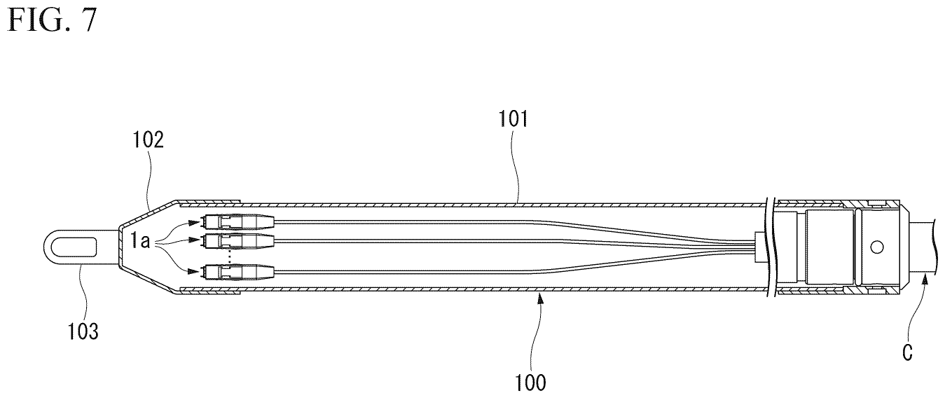

As shown in FIG. 7, the connector 1a may be temporarily housed inside the pulling end 100. The pulling end 100 is used in a case where an optical cable C is laid in a building or the like. In particular, in a case where the optical cable C is laid in a narrow space such as a micro duct, the pulling end 100 may be used. The optical cable C has a plurality of connectors 1a. The pulling end 100 is temporarily mounted onto a distal end of the optical cable C. The pulling end 100 has a tubular body 101, a head 102, and a pulling eye 103. A plurality of connectors 1a are housed in the tubular body 101. The head 102 is attached to a distal end of the tubular body 101. The pulling eye 103 is fixed to the head 102.

In a case where the optical cable C is laid, for example, the work is performed in the following procedure.

First, the optical cable C (cable with a pulling end) in a state in which the pulling end 100 is attached is prepared. In the state of the cable with a pulling end, the coupling 30 is not attached to the housing 20. In the state of the cable with a pulling end, the biasing member 50 is stored in the rear storage 22.

Next, the pulling eye 103 is pulled, and the optical cable C is inserted through the micro duct or the like.

Next, the optical cable C is removed from the pulling end 100 to expose the connector 1a.

Next, the biasing member 50 is rotated to the front about the O axis and is stored in the front storage 21 (see FIG. 4).

Next, the coupling 30 is mounted onto the housing 20 (see FIG. 5). As described above, the assembling of the optical connector 1 is completed.

In order to improve the efficiency of the work of constructing an optical line, more connectors 1a may be housed inside the pulling end 100. In one or more embodiments, the connector 1a is housed inside the pulling end 100 in a state in which the coupling 30 is not mounted. As viewed from the longitudinal direction Z, the projection area of the connector 1a is smaller than the projection area of the optical connector 1. This is because the coupling 30 is not mounted in the state of the connector 1a. In other words, as the coupling 30 is not provided, it is possible to house more connectors 1a inside the pulling end 100.

The biasing member 50 of one or more embodiments is rotatable about the O axis extending in a direction that differs from the longitudinal direction Z. With this configuration, it is possible to transition the biasing member 50 from the pre-assembly state (FIG. 3) to the assembled state (FIG. 2 or the like). In the assembled state, the biasing member 50 protrudes from the recess 20c. In the pre-assembly state, the protruding amount of the biasing member 50 is smaller than that in the assembled state. In one or more embodiments, in the pre-assembly state, the entire biasing member 50 is stored in the recess 20c.

In this way, by housing the plurality of connectors 1a inside the pulling end 100 in the pre-assembly state, it is possible to further reduce the projection area of the connector 1a as viewed in the longitudinal direction Z. Also, it is possible to easily transition the biasing member 50 from the pre-assembly state to the assembled state by the operation of rotating the biasing member 50 about the O axis. Since the biasing member 50 is supported by the support 63, the biasing member 50 is unlikely to fall off the housing 20 even in a state in which the coupling 30 is not present. As described above, it is possible to easily perform the work of assembling the optical connector 1.

As described above, the optical connector 1 of one or more embodiments includes the optical fiber F, the ferrule 10 having the fiber hole 12 through which the optical fiber F is inserted and the connecting end face 11 to which the fiber hole 12 opens, the housing 20 that holds the ferrule 10, the coupling 30 that surrounds the housing 20, and the biasing member 50 that is disposed between the housing 20 and the coupling 30 to bias the coupling 30 to the front. The biasing member 50 is rotatable about the O axis extending in a direction (for example, the orthogonal direction Y) that differs from the longitudinal direction Z of the fiber hole 12 in a state in which the coupling 30 is not mounted onto the housing 20.

According to the optical connector 1 having this configuration, it is possible to easily change the position of the biasing member 50 from the pre-assembly state to the assembled state. Therefore, it is possible to easily change the posture of the biasing member 50 from the pre-assembly state in which the projection area is small to the assembled state in which it is possible to have the coupling 30 be biased. Accordingly, it is possible to increase the possible number of connectors 1a that are housed in the pulling end 100, and it is possible to facilitate easy assembly of the optical connector 1.

The biasing member 50 may be a leaf spring. In this case, it is possible to further reduce the projection area of the connector 1a. In other words, it is possible to house more connectors 1a in the pulling end 100.

The support 63 that rotatably supports the biasing member 50 may be disposed inside the recess 20c. In this case, it is possible to reduce the projection area of the connector 1a, compared to a case where the support 63 is provided outside the recess 20c.

The biasing member 50 may include the proximal end 51 that is supported by the support 63, the abutter 52 that is in contact with the housing 20, and the biaser 53 that is positioned between the proximal end 51 and the abutter 52 and is in contact with the coupling 30. With this configuration, it is possible to have the coupling 30 be forward biased (toward the connecting end face 11 side) using the biasing member 50.

The recess 20c may have the rear storage 22 that is positioned behind the support 63. The length L1 of the rear storage 22 in the longitudinal direction Z may be longer than the length L2 from the proximal end 51 to the abutter 52. According to this configuration, it is possible to store the biasing member 50 in the rear storage 22 in a state before the coupling 30 is mounted. Therefore, it is possible to further reduce the projection area of the connector 1a in the pre-assembly state.

In the method for assembling the optical connector 1 of one or more embodiments, the connector 1a in a state in which the coupling 30 is not mounted is taken out from the inside of the pulling end 100, the biasing member 50 is rotated about the O axis, and the housing 20 is inserted into the coupling 30. According to such an assembling method, it is possible to house more connectors 1a inside the pulling end 100. Therefore, the efficiency in a case where the optical cable C is laid using the pulling end 100 is improved.

The technical scope of the present invention is not limited to the above-described embodiments, and various modifications may be made so long as the technical scope of the present invention is not departed from.

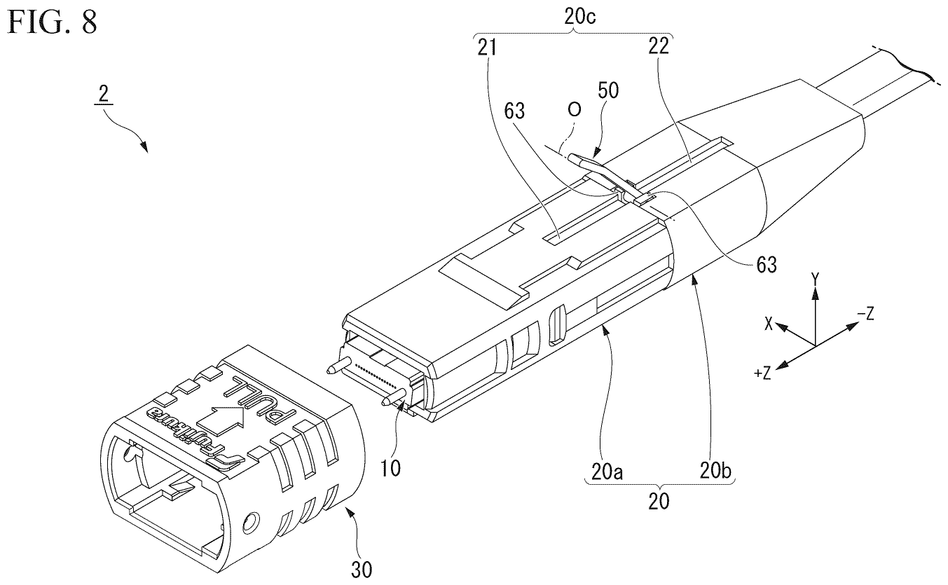

For example, in the above embodiments, the biasing member 50 and the recess 20c are disposed on both ends of the optical connector 1 in the parallel direction X. However, as shown in FIG. 8, the biasing member 50 and the recess 20c may be disposed on both ends of the optical connector 1 in the orthogonal direction Y. Then, the O axis that is a rotation center of the biasing member 50 may extend in the parallel direction X. In this case as well, the same effects as those of the embodiments described above are obtained.

The O axis may extend in a direction that differs from the longitudinal direction Z. A direction in which the O axis extends may not coincide with the orthogonal direction Y or the parallel direction X.

The support 63 that rotatably supports the biasing member 50 may be provided in the housing 20 instead of the spring push 60.

The recess 20c of the embodiments described above has the front storage 21 and the rear storage 22. However, a structure in which the recess 20c does not have one of the front storage 21 and the rear storage 22 may also be employed. For example, even in a case where the front storage 21 is not provided, the coupling 30 may be forward biased by the biasing member 50. Even in a case where the rear storage 22 is not provided, in a case where the projection area of the connector 1a in the pre-assembly state is smaller than the projection area of the connector 1a in the assembled state, the effect of being “possible to house more connectors 1a in the pulling end 100” is obtainable.

The biasing member 50 may not be a leaf spring. In a case where the biasing member 50 is rotatable about the O axis and it is possible to easily transition from the pre-assembly state to the assembled state, an effect of improving the assemblability is obtainable.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 . . . Optical Connector, 10 . . . Ferrule, 11 . . . Connecting End Face, 12 . . . Fiber Hole, 20 . . . Housing, 20c . . . Recess, 22 . . . Rear Storage, 30 . . . Coupling, 50 . . . Biasing Member, 51 . . . Proximal End, 52 . . . Abutter, 53 . . . Biaser, 63 . . . Support, 100 . . . Pulling End, F . . . Optical Fiber, O . . . Axis, Z . . . Longitudinal Direction

1. An optical connector comprising:
an optical fiber;
a ferrule that has:
a fiber hole through which the optical fiber is inserted; and
a connecting end face to which the fiber hole opens;
a housing that holds the ferrule;
a coupling configured to be mounted onto and surround the housing; and
a biasing member that biases the coupling in a direction of the connecting end face, wherein
the biasing member is configured to rotate about an axis extending in a direction that differs from a longitudinal direction of the fiber hole in a state in which the coupling is unmounted.

2. The optical connector according to claim 1, wherein the biasing member is a leaf spring.

3. The optical connector according to claim 1, wherein
the housing has a recess that allows the biasing member to be stored therein, and
the housing comprises a support that rotatably supports the biasing member inside the recess.

4. The optical connector according to claim 3, wherein
the support supports a proximal end of the biasing member, and
the biasing member comprises:
an abutter in contact with the housing; and
a biaser between the proximal end and the abutter and that contacts the coupling.

5. The optical connector according to claim 4, wherein
the recess comprises a rear storage behind the support, and
the rear storage is longer than a distance from the proximal end to the abutter in the longitudinal direction.

6. A method for assembling an optical connector according to claim 1, the method comprising:
taking out, from an inside of a pulling end of an optical cable, the optical connector in a state in which with the coupling is unmounted;
rotating the biasing member about the axis, and
inserting the housing into the coupling.
